(19) United States
(12) Patent Application Publication
(10) Pub. No.: US 2026/0220676 A1
(43) Pub. Date: Jul. 30, 2026

(54) CENTRAL ELECTRONIC HUB FOR PARTICIPANTS AND FULFILLMENT

(71) Applicant: Walmart Apollo, LLC, Bentonville, AR (US)

(72) Inventors: Praveenchandra Hegde, Bengaluru (IN); Bhanuraj Km, Bangalore (IN); Satya Teja Burra, Hyderabad (IN); Anurag Mitra, Bengaluru (IN); Jilson Joseph, Bengaluru (IN); Yogesh Rawat, New Delhi (IN); Prakash Kamani, Bengaluru (IN); Vivek Sharma, Bangalore (IN); Aditya Ajay Athalye, Bangalore (IN); Kedaranath Bhat, Bangalore (IN); Monark Koshta, Bangalore (IN); Thiyagarajan Ramasamy, Bangalore (IN); Ashish G. Kamdar, Ashburn, VA (US); Srivani Amrutavakkula, Sunnyvale, CA (US)

(21) Appl. No.: 19/041,327

(22) Filed: Jan. 30, 2025

(51) Int. Cl. G06Q 30/0601; G06Q 10/0835; G06Q 10/087

(52) U.S. Cl. CPC G06Q 30/0603; G06Q 10/0835; G06Q 10/087

(57) ABSTRACT

A system includes an electronic database, a central hub processing resource, and a computer readable medium storing instructions that, when executed by the processing resource provide a client center user interface to receive catalog information from a client side system, electronically store the catalog information in the electronic database, and provide a fulfillment gateway. The fulfillment gateway integrates the client side system with a plurality of hub participants by making information input by the client side system accessible to the hub participants. Electronic orders are received at the hub according to the published catalog. The electronic orders are processed by the processing resource and a fulfillment option is accessed to fulfill the electronic order. The ordered item is picked and delivered to the customer.

### TECHNICAL FIELD

This disclosure relates generally to fulfillment and more specifically to coordination between fulfillment participants.

### BACKGROUND

Different vendors may provide products or services, and may receive orders from customers for products or services. The vendors then pass the orders received from customers to retailers. For example, a customer may wish to order a food product from a retailer and place and order through a delivery service. The delivery service then contacts the retailer to place the order, picks up the order at the retailer, and then delivers the order to the customer. In other examples, a retailer may directly ship the order to the customer.

### BRIEF DESCRIPTION OF DRAWINGS

Disclosed herein are embodiments of systems, apparatuses and methods pertaining to central electronic hubs for fulfillment of products and/or services. This description includes drawings, wherein:

FIG. 1 is a block diagram of a central hub system in accordance with several embodiments.

FIG. 2 is a block diagram of a central hub system in accordance with several embodiments.

FIG. 3A is a block diagram of a central hub system in accordance with several embodiments.

FIG. 3B is a diagram of operation of a central hub system in accordance with several embodiments.

FIG. 3C is a block diagram of a processor of a central hub system in accordance with several embodiments.

FIG. 4 is a flow diagram of an approach for integration and item fulfillment in accordance with several embodiments.

FIG. 5 is a block diagram of a processing resource in accordance with several embodiments.

FIG. 6 is a flow diagram of a fulfillment process in accordance with several embodiments.

FIG. 7 is a flow diagram of a fulfillment process in accordance with several embodiments.

FIG. 8 is a flow diagram of a fulfillment process in accordance with several embodiments.

FIG. 9 is a flow diagram of a fulfillment process in accordance with several embodiments.

FIG. 10 is a catalog file in accordance with several embodiments.

FIG. 11 is a block diagram of a user interface for a retailer in accordance with several embodiments.

FIG. 12 is a block diagram of user interface for a vendor in accordance with several embodiments.

FIG. 13 is a table of orders in accordance with several embodiments.

FIG. 14 is a block diagram of a vendor system in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to fulfill product orders. A central hub (also referred herein as “the hub” or a “marketplace hub”) is provided whereby marketplace vendors interact electronically with one or more retailers, for example, to receive catalog information from the retailers and to place orders from the catalogs. Retail stores can subscribe to different features or integrations such as particular shipping services, picking services and/or delivery services. Instant access to these features is provided to marketplace vendors after they are allowed access to the hub. State machines (e.g., that models processes such as a processes for handling out-of-stock items, processes that provide shipping fulfillment approaches, processes that provide delivery fulfillment approaches, and processes that provide pickup fulfillment approaches) can be configured and customized based upon a retailer's needs.

In the approaches provided, a one-time integration may be built between a marketplace vendor and one or more retailers making the system flexible and efficient. In greater detail, a one-time integration may be constructed (between the vendor and potentially multiple retailers) using the central hub, and seamless access to multiple marketplaces (each including potentially multiple vendors) for retailers is provided. Advantageously, if there are n retailers (e.g., n food stores) and m marketplace vendors, (e.g., m food delivery services), then n*m separate individual integrations (e.g., separate individual connections between retailers and vendors) do not need to be constructed. Instead, the central hub is used and only n plus m integrations are used or required.

In more detail, the hub receives a retailer's product catalog (e.g., in electronic form), stores the catalog information, stores inventory updates concerning products in the catalog, and then publishes this information to multiple pre-integrated marketplace vendors (e.g., product delivery services). Once a retail customer places an order from a specified retailer (using a vendor app or the website of the vendor), the order is communicated to the hub via the marketplace vendor. The hub receives the order and orchestrates (e.g., manages/processes) the order. In these regards, the hub communicates with the picking and/or shipping systems of the specified retailer to automatically pick, pack and dispatch the products (e.g., through a shipping service or a delivery service driver).

As mentioned, the hub may incorporate a one-time integration with each marketplace vendor, enables seamless access to retailers, and eliminates the multiple integrations between retailers and marketplace vendors. Integration of a retailer with the hub may include uploading, from the retailer, store hours, a product catalog, and/or any additional information generally required by a retailer when establishing a connection with a vendor. In these regards, a retailer may enter the appropriate information once to integrate with the hub, rather than enter the appropriate information with each vendor the retailer wishes to integrate with.

Also as mentioned, the approaches described herein provide subscription-based immediate access to all product features and integrations. For example, retailers can create subscriptions or subscription templates that provide features/integrations such as specific fulfillment services (e.g., use of shippers A, B, or pickup by a delivery driver), and picking approaches. A vendor upon integration with a retailer may subscribe to a select subset of these features/integration (e.g., picking services and not shipping services). This feature of the hub provides new marketplace vendors with instant access to utilize these features/integrations. Each retailer can also customize the states and actions triggered by state changes when an order is processed. For example, a retailer can choose to trigger or set an inventory out-of-stock indicator across all marketplace vendors via the hub when an item is nil picked (e.g., the picker cannot locate the item in the store) during fulfillment of one of the orders received from any marketplace vendor.

In further aspects, the hub includes a client center user interface for retailers to interact with the hub. In further detail, the client center user interface allows retailers to upload appropriate information required for integration (e.g., store hours and a product catalog). Further, the client center user interface allows a retailer to view multiple orders from multiple vendors in one location. In previous approaches, a retailer typically communicated with and received orders from an interface corresponding with a specific vendor. The client center user interface aggregates orders from each marketplace vendor into a single interface to simplify order fulfillment processes by the retailer.

It is noted that some terms may be used interchangeably through the application. For example, one or more of: a “retailer” may be referred to as a “client side system”; a “marketplace vendor” (or “vendor”) may be referred to as a “hub participant” (or “participant”); and picking services and/or shipping services may be referred to as “fulfillment options”.

In many of these embodiments, a system includes an electronic database, a central hub processing resource coupled to the electronic database, and a computer readable medium. The computer readable medium stores instructions that, when executed by the central hub processing resource cause the central hub processing resource to provide a client center user interface to receive a catalog and catalog information from a client side system (retailer) and electronically store the catalog information in the electronic database, provide a fulfillment gateway, process electronic orders; and electronically access, for each of the electronic orders, a fulfillment option to fulfill the electronic order. The fulfillment option electronically instructs a robot or a person to locate and pick an item in a retail facility of the client side system to fulfill the electronic order and receives the item that has been picked and delivers the item to a customer.

In some embodiments, the fulfillment gateway integrates the client side system with a plurality of hub participants by making information input by the client side system via the client center user interface accessible to each of the plurality of hub participants (the information is stored in the electronic database), electronically publishes the catalog, and receives the electronic orders according to the published catalog, the plurality of hub participants (vendors) interacting with the client side system (retailer) via the fulfillment gateway.

In aspects, the central hub processing resource comprises multiple processing resources. For example, multiple servers or processors may be used.

In other examples, the central hub processing resource creates a subscription template from information received from the client side system (retailer) via the client center user interface and processes the electronic orders based upon the template. In some aspects, the template describes specific shippers or picking approaches provided by the client side system (retailer). In other aspects, the client side system (retailer) dynamically changes the template over time.

In still other examples, the client side system (retailer) instructs, via the client center user interface, the central hub processing resource to customize an action triggered by a state change that occurs during shipping or picking. In one example, the state change is a nil pick, and the action is triggering an out-of-stock alert or indicator across all participants (marketplace vendors), and the out-of-stock alert or indicator is associated with a product of the electronic customer order that is nil picked.

In yet other aspects, the catalog information comprises information concerning one or more of products, prices of the products, and availability of the products. Other examples are possible.

In yet other examples, the system further comprises a data lake. In aspects, the data lake obtains information concerning orders from the hub participants (marketplace vendors) and the central hub processing resource accesses the data lake to obtain analytic information about products stored at the data lake. In some examples, the analytic information comprises information concerning one or more of: top selling products, daily sales, nil picks, and cancellation trends.

In others of these embodiments, a client center user interface is provided to receive a catalog and catalog information from a retailer and electronically storing the catalog information in an electronic database. A fulfillment gateway is provided, and the fulfillment gateway integrates the retailer with a plurality of marketplace vendors by making information input by the retailer via the client center user interface accessible to each of the plurality of marketplace vendors, wherein the information is stored in the electronic database; electronically publishes the catalog; and receives electronic orders according to the published catalog, the plurality of marketplace vendors interacting with the retailer via the fulfillment gateway.

In some embodiments, electronic orders are processed and for each of the electronic orders, a picking service and a shipping service are electronically accessed to fulfill the electronic order. The picking service electronically instructs a robot or a person to locate and pick an item in a retail facility of the retailer to fulfill the electronic order. The shipping service receives the item that has been picked and delivers the item to a customer.

In others of these embodiments, a non-transitory machine readable medium stores instructions that, when executed, cause a central hub processing resource to perform various functions or actions. These functions include providing a client center user interface to receive a catalog and catalog information from a retailer and electronically storing the catalog information in an electronic database; providing a fulfillment gateway. The fulfillment gateway integrates the retailer with a plurality of marketplace vendors by making information input by the retailer via the client center user interface accessible to each of the plurality of marketplace vendors, wherein the information is stored in the electronic database; electronically publishes the catalog; and receives electronic orders according to the published catalog, the plurality of marketplace vendors interacting with the retailer via the fulfillment gateway.

In some embodiments, the functions or actions also include processing the electronic orders, and electronically access, for each of the electronic orders, a picking service and a shipping service to fulfill the electronic order. The picking service electronically instructs a robot or a person to locate and pick an item in a retail facility of the retailer to fulfill the electronic order. The shipping service receives the item that has been picked and delivers the item to a customer.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

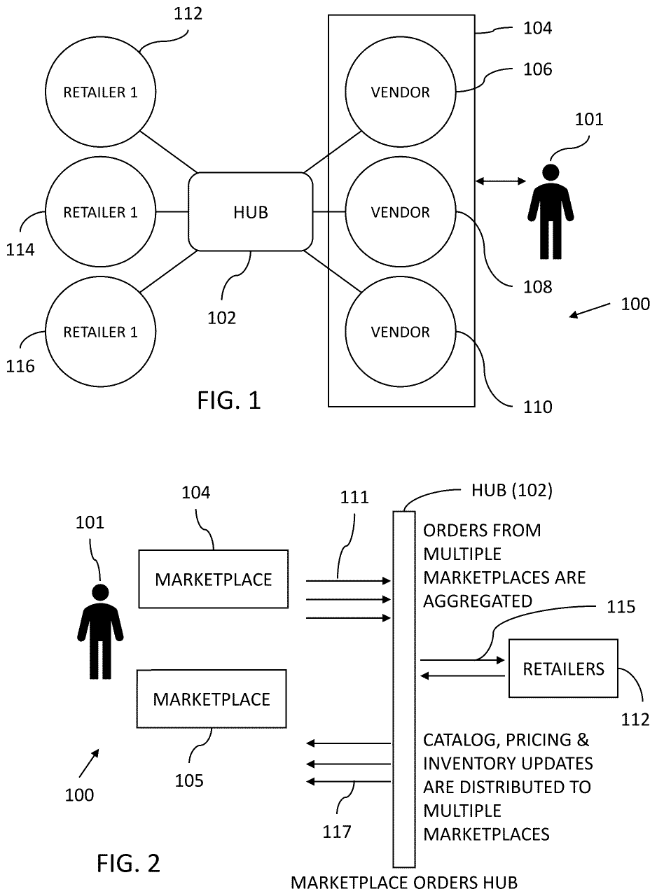

Referring now to FIG. 1 and FIG. 2, a system 100 includes a hub 102, a first marketplace 104 (including vendors 106, 108, and 110), and a second marketplace 105. For simplicity, no vendors are shown in the second marketplace 105 but it will be understood that the second marketplace 105 includes one or more vendors. The system also includes a first retailer 112, a second retailer 114, and a third retailer 116. A customer 101 places orders through the marketplaces 104 and 105 where the orders are eventually fulfilled by one or more of the retailers 112, 114, and 116. It should be understood that the techniques described herein may operate with any number of marketplaces, vendors, and retailers, and are not limited to the arrangement illustrated in FIGS. 1 and 2.

The hub 102 provides a seamless integration and electronic communication path between the marketplaces 104 and 105 (and their associated vendors) and the first retailer 112, second retailer 114, and third retailer 116. The hub 102 is electronically connected to the marketplaces 104 and 105 (and the vendors 106, 108, and 110 in the marketplaces) and the first retailer 112, second retailer 114, and third retailer 116. The electronic connection can be provided via one or more electronic communication networks such as wireless networks or the internet.

The hub 102 provides various processing, routing, and electronic communication functions. For example, the hub 102 receives catalog information from retailers, stores the information, selectively publishes the information to vendors, receives orders from vendors, processes the orders according to the wishes of the retailers, communicates with the retailers including sending picking and/or shipping instructions to the retailers.

As described below, the hub 102 may include one or more processing resources. For example, the hub 102 may include multiple electronic servers (or processors), each of the servers may cooperatively communicate with one or more of the other servers, and each of the servers may provide specific (and different from the other servers) processing functionality. The hub 102 may also include one or more databases or memories.

In some aspects, the hub 102 further includes a catalog service (e.g., a database) which consolidates partner catalogs (e.g., from multiple retailers accessible from a vendor) into a unified marketplace of integrated retail systems. A gateway service mediates and streamlines interactions between the hub 102 and marketplaces (e.g., 104, 105) such that a retailer integrates once with the hub 102 and is onboarded/integrated with multiple marketplaces consequently. In some aspects, the catalog service exposes application programming interfaces (APIs) to internal services of the hub 102 to retrieve catalog related information during order fulfillment.

The marketplaces 104 and 105 are organized according to various criteria. For example, one marketplace may relate to restaurants while other marketplaces relate to vendors that supply consumer products. In some aspects, marketplaces 104, 105 are organizational structures which categorize types of vendors (e.g., a food marketplace may include a plurality of vendors each cooperated with various food retailers, a clothing marketplace may include a plurality of vendors each cooperated with various clothing sellers/retailers, etc.). In some aspects, a marketplace 104, 105 may itself be a vendor (e.g., vendors 106, 108, 110) that directly communicates with a retailer via the hub 102, and include physical structures associated with a vendor (e.g., processors, interfaces, applications, etc.). For example, a marketplace 104, 105 may include an electronic interface to connect (e.g., via a network) a customer 101 with vendors 106, 108, 110 and/or to connect (e.g., via the hub 102) a customer 101 with retailers 112, 114, 116.

The vendors 106, 108, and 110 relate to or represent entities that supply various items such as products or services to customers. For example, the vendors 106, 108, 110 may be delivery services for restaurant or consumer items. As implemented, the vendors 106, 108, and 110 may be websites with interfaces that receive electronic orders from customers. For example, a vendor 106, 108, 110 may be a website and/or mobile application that is connected to multiple restaurants (e.g., retailers 112, 114, 116). A customer 101 utilizing the vendor 106, 108, 110 may open the corresponding website and/or application of the vendor 106, 108, 110 (e.g., on a user device such as a mobile device, computer, etc.) and navigate the website/application (e.g., via a search interface of the website/application) in order to view retailers 112, 114, 116 and place orders. The vendors 106, 108, 110 may be third-party applications through which a customer 101 can place an order from a retailer 112, 114, 116. In some aspects, the vendors 106, 108, 110 facilitate in the fulfillment of an order with a retailer 112, 114, 116 (e.g., certain vendors pertain to shipping, certain vendors pertain to delivery, certain vendors pertain to pick up, and so forth). Generally, a vendor 106, 108, 110 allows a customer 101 to view and/or purchase items from multiple retailers 112, 114, 116 (in comparison to viewing and/or purchasing items directly from a website/application of a retailer 112, 114, 116). The vendors 106, 108, and 110 receive electronic catalogs from the hub 102. The vendors 106, 108, and 110 then receive orders from customers and send these orders to the hub 102 for processing and fulfillment.

For example, a food vendor may include multiple restaurants selling various types of food and/or food dishes. A customer 101 may navigate the website/application of the food vendor (e.g., by a search bar and/or selectable categories) to indicate a style of food, a specific food dish, a specific restaurant, etc., that the customer 101 is interested in. The website/application of the food vendor may display relevant restaurants, types of food, food dishes, etc., based on the customer input, and the customer 101 may further select, for example, a restaurant (e.g., a retailer) to place an order through. Upon selecting a specific restaurant, the customer 101 may navigate food items available for purchase by the customer from the restaurant. The vendor website/application may further indicate specific food items that are out of stock, food items that are low stock, popular purchases, suggested item pairings (from the same retailer and/or from a different retailer), historical purchases of the customer 101, and so forth. The customer 101 may select items from the restaurant to add to a virtual cart to purchase. In some aspects, each restaurant (e.g., retailer) may have a respective virtual cart on an application/website of a food vendor, while in some aspects, items from multiple restaurants (e.g., retailers) may be aggregated into a single virtual cart associated with the customer 101. In other words, a customer 101 can purchase items from multiple restaurants in one transaction. In some aspects, different food vendors (e.g., vendors 106, 108, 110) may interact with any combination of the same or different restaurants (e.g., retailers 112, 114, 116). While the present example describes food retailers and restaurants as the vendors 106, 108, 110 and the retailers 112, 114, 116 respectively, it is contemplated that there may be any different genre/category of vendors 106, 108, 110 and retailers 112, 114, 116 used (e.g., clothing, general retail, food, electronics, etc.).

The hub 102 provides various features/functions that provide electronic product or service catalogs to vendors. By “catalog,” it is meant a listing of items/products available for purchase by a customer 101 from a retailer 112, 114, 116. For example, a retailer 112, 114, 116 that sells food (e.g., a restaurant) may have an associated catalog with menu items available for purchase at the restaurant. In another example, a retailer 112, 114, 116 that is a generalized retail store may have an associated catalog with all items generally stocked at the specific retail store (i.e., a retailer 112, 114, 116 with multiple locations and/or an e-commerce platform may upload a catalog associated with a specific location of the retailer 112, 114, 116 including products specific to the products sold at the specific location). In some embodiments, a retailer 112, 114, 116 is a company with multiple locations, while in some aspects a retailer 112, 114, 116 is a specific location of a specific company. The catalog can be updated and/or altered at any point in time by the associated retailer 112, 114, 116. In some aspects, the catalog includes multiple criteria related to each item in the catalog in order to navigate and categorize the items in the catalog. In some embodiments, the catalog information includes information concerning products, prices of the products, and/or availability of the products.

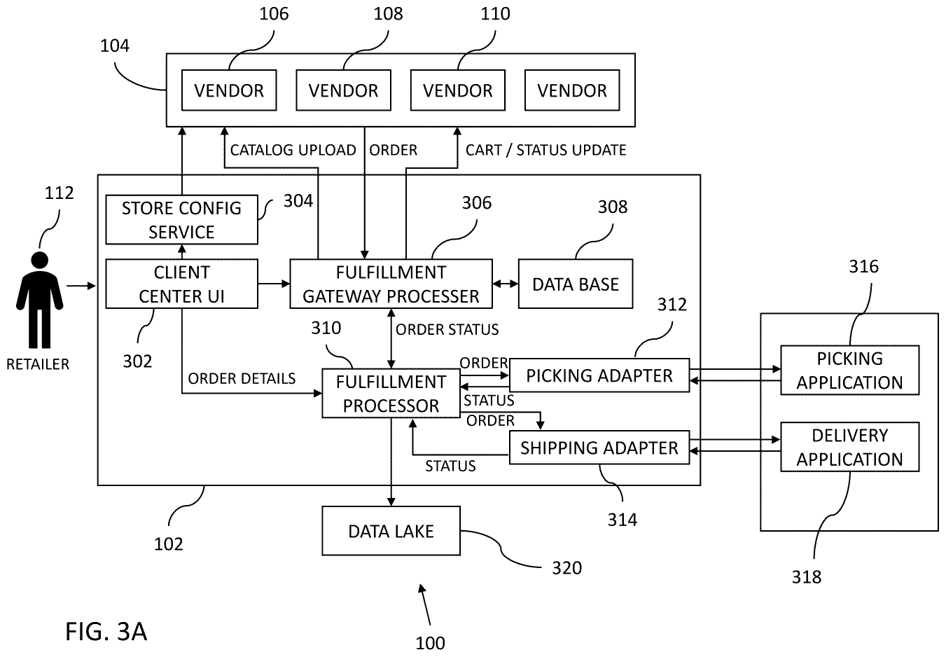

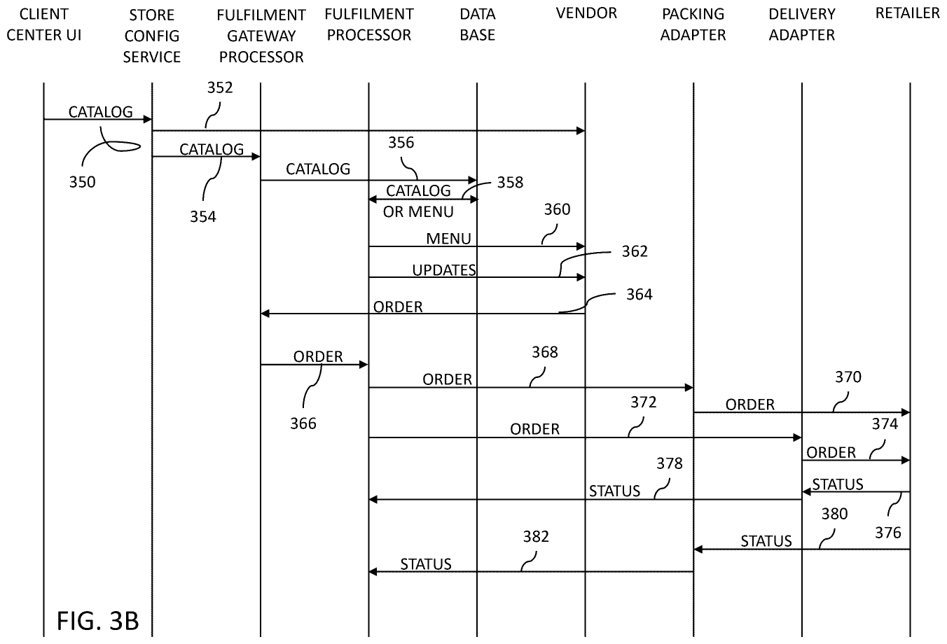

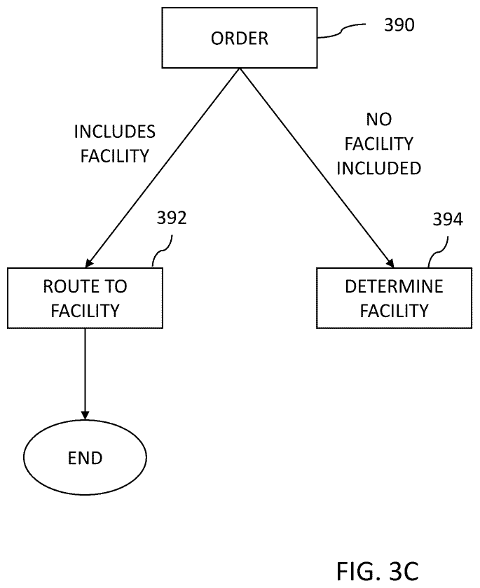

The hub 102 receives the catalog from the retailer via a retailer interface (e.g., the client center user interface 302 shown in FIG. 3A). Generally, a retailer is required to input the catalog information once via the interface, however, a retailer may make subsequent amendments (e.g., removing products, adding products, changing information associated with a product and so forth) to the catalog after the initial receival of the catalog at the hub 102. The catalog may be stored at the hub in a database or memory at the hub 102.

The hub 102 publishes the catalog to the vendors. By “publish,” it is meant that the catalog of a respective retailer is viewable by the vendors (e.g., via a vendor website). Generally, a retailer may upload catalog information once to the hub 102, and the information is electronically published to each of the vendors the respective retailer is integrated with. By “integrate”, it is meant that a vendor is in communication with a retailer and that customers are able to place orders through the vendor to be fulfilled by the retailer. In previous approaches, a retailer typically uploaded a catalog for each vendor the retailer wished to integrate. However, in the present approaches, a retailer uploads a single catalog that is published to all vendors a retailer wishes to integrate.

The hub 102 provides various processing features for orders received from the vendors. In some aspects, the hub 102 routes an order to a specific facility of a retailer that is specified in the order. In this case, the hub 102 receives an order that is meant to be fulfilled by a specific retailer at a specific location (the customer 101 specifies the location), and routes it to or contacts that retailer at that specific location. For example, the hub 102 may receive an order (from a vendor that has received a customer order from the customer 101) for some specific food item for a restaurant at a specific location or a product from a retailer at a particular address) and then routes it to that specific facility. In one example, a customer may place an order through a vendor for pickup at a specific location (e.g., nearby the customer) of the retailer.

In other examples, the order does not specify a particular retailer facility for order fulfillment, the hub 102 routes an order to the specific retailer (but not a specific facility of the retailer), and the retailer decides how to fulfill the order (e.g., which facility to use). In this case, the hub 102 receives an order that is meant to be fulfilled by a specific retailer (but not a specific facility of the retailer), and routes it to or contacts that retailer. The retailer may have multiple facilities or stores, but after receiving picking or shipping messages from the hub 102, the retailer determines internally which facility will fulfil the order. In one example, a customer may place an order through a vendor to be shipped, and the specific facility of the retailer may correspond with, for example, an order fulfillment location which has more items from the order than an alternate order fulfillment location.

In still other examples, the order does not specify a particular retailer facility for order fulfillment, and the hub 102 determines a specific facility of the retailer to use. The hub 102 determines the specific facility based upon predetermined criteria. For example, the hub 102 may receive an order (from a vendor that has received a customer order) for some specific food item. The order is for a food item from a particular chain of restaurants, but not a particular facility of the restaurant. The hub determines the particular restaurant facility to fulfill the order (e.g., using such factors as the wait time at particular restaurants or how far particular restaurants are from the customer 101 to mention a few examples). In one example, a customer places an order through a vendor for delivery, and the hub 102 picks a specific facility (e.g., from multiple facilities of the same retailer) to deliver the item from based on the proximity of, for example, a delivery driver to the relevant facilities.

In yet other examples, the order only specifies a product (not a retailer) and the hub 102 determines the retailer and/or facility of the retailer to use. For example, the hub 102 may receive an order for paper towels and determines the retailer to use. This selection may be made based upon a wide range of factors such as price, volume discounts, or location of the retailer to mention a few examples.

Once the retailer receives the order, various actions can be performed. As will be described in greater detail, the retailers may have various fulfillment options such as picking services (where the retailer locates a product in an order within a physical facility) and shipping services (where the retailer facilitates shipping and/or delivery of an order). In some aspects, picking services are performed by an associate of a facility in fulfilling/aggregating the items of an order, while in some aspects picking services are performed by an associate of a third-party fulfillment service (e.g., someone employed by a vendor to pick and deliver an order to a customer). In some aspects, the shipping services are third-party shipping companies, which a retailer may utilize in order to physically ship an order to a customer. In some aspects, delivery services are retailer specific delivery services (e.g., a delivery driver employed by the retailer) and/or third-party delivery services (e.g., a delivery driver of a vendor and/or alternate delivery provider to fulfill the order placed by the customer through the vendor).

Referring specifically now to FIG. 2, interactions between the system components are shown in greater detail. In this example, the marketplaces 104 (e.g., 106, 108, 110) place orders 111 to the hub 102. Generally, the orders 111 include items purchased by a customer, an order fulfillment method (e.g., delivery, shipping, etc.), a delivery address for the order (e.g., when the order is placed for delivery and/or shipping), a payment method associated with the purchase, and so forth. The hub 102 orchestrates these orders (e.g., through various networks and/or gateways connecting the marketplaces/vendors with the retailer(s)) and interactions 115 with the retailer 112. These interactions 115 include picking interactions (e.g., indicating to an operator (e.g., a mobile robot, a customer, a store associate, a vendor associate, etc., picking the order) the physical location of items in the order within the facility), shipping interactions (e.g., to orchestrate pickup, delivery, and/or shipping of an order via cars, trucks, planes, trains, and the like). Pickup services are generally a person (e.g., the customer or alternate person designated to retrieve the order) retrieving the order directly with no additional service provided to deliver the order. Generally, delivery services refers to fulfillment of an order from a retail facility (e.g., allowing in store shopping/ordering) to a customer, and shipping services refer to fulfillment of an order from an order fulfillment facility (e.g., requiring services of a shipping carrier in order to for the customer to receive the order). In terms of the system 100 architecture, the interactions 115 may physically be control signals, acknowledgments, and the like, which communicate with additional components in order to facilitate the physical interactions associated with a respective signal (e.g., a control signal that distinguishes picking, delivery, and shipping).

Updates 117 (e.g., cataloging, pricing, and inventory updates) may be sent from the hub 102 to the marketplaces 104 and/or 105. In these regards, the hub 102 may store information and/or automatically track information such as retailer inventory (e.g., suppled or changed by the retailer), prices (e.g., supplied or changed by the retailer), or cataloging information (e.g., supplied by the retailer). This information may be periodically sent to the marketplaces or sent when a change occurs in the form of electronic updates. For example, a price change made by the retailer may be communicated to the hub 102 by the retailer. The hub 102 stores this information. The information is then passed to the vendors (e.g., the website of the vendor) where it can also be stored. The next time a customer places an order via the website for the item, the updated price is shown.

Referring now to FIG. 3A, further details of the hub 102 are described. The hub 102 includes a client center user interface 302, a store configuration service 304, a fulfillment gateway processor 306, a database 308, a fulfillment processor 310, a picking adapter 312, and a shipping adapter 314. Other processors can also be used, and it also will be appreciated that the fulfillment gateway processor 306, fulfillment processor 310, and potentially other processors may be included in a single processor. It will also be understood that the term “processor” is synonymous with all types of processers, servers, controllers, or control circuits.

It is generally contemplated that the system 100 and any processors thereof (e.g., the fulfillment gateway processor 306, the fulfillment processor 310, and/or any additional processors) may include any suitable processing resource configured to execute instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processor or controller may be configured (for example, by using corresponding programming stored in a memory as will be well understood by those skilled in the art) to carry out one or more of the steps, actions, and/or functions described herein.

The client center user interface 302 is an interface that allows a retailer (e.g., 112, 114, 116) to communicate with various vendors (e.g., 106, 108, 110). For example, a retailer may upload a product catalog, store hours, store location, etc., through a physical interface (e.g., a website or application) of the client center user interface 302. The client center user interface 302 may interact with and/or be coupled to additional components of the hub 102 including the store configuration service 304, the fulfillment gateway processor 306, and/or the fulfillment processor 310. In some aspects, information uploaded by a retailer via the client center user interface 302 is stored in the database 308 to be utilized by additional components of the hub 102. In some aspects, the client center user interface 302 includes a processor internal to the client center user interface 302, while in some aspects the client center user interface 302 communicates with a processor external to the client center user interface 302 (e.g., the fulfillment gateway processor 306, the fulfillment processor 310, and/or a specific client center user interface external processor). Generally, the client center user interface 302 facilitates the uploading and communication between a retailer and marketplaces (e.g., 104,105)/vendors (e.g., 106, 108, 110). In some aspects, the client center user interface 302 further aggregates orders placed through each of the vendors (e.g., 106, 108, 110) onto a single display interface to be viewed and/or interacted with by the respective retailer.

The store configuration service 304 configures location specific information of a retailer (e.g., 112) to be output to vendors (e.g., 106, 108, 110). For example, store specific information including store hours, store address, customer service hours, product catalogs, and the like, may be designated by a retailer (e.g., via the client center user interface 302) and processed/output to the vendors via the store configuration service 304. In some aspects, the store configuration service 304 is in communication with and/or executable by the client center user interface 302 (and/or other processing devices) in order to perform the described functions. In some aspects, the store configuration service 304 is an interface of the client center user interface 302 on which the described store specific information is customizable by a retailer.

The fulfillment gateway processor 306 facilitates communication between the retailer (e.g., 112) and the vendors (e.g., 106, 108, 110). In some aspects, the fulfillment gateway processor 306 receives catalog and/or alternate store specific information via the client center user interface 302 and/or the database 308, and provides the information to the vendors (e.g., vendors 106, 108, 110). In some embodiments, the fulfillment gateway processor 306 uploads catalog information to be viewable by customers via a vendors, provides status (e.g., out of stock, low stock, etc.) updates for products viewable by a customer (e.g., in a cart of a customer, in a product listing for a retailer, etc.). In other words, the fulfillment gateway processor 306 integrates the retailer (e.g., retailer 112) with the plurality of vendors (e.g., vendors 106, 108, 110) by establishing a single communication path between the vendors and retailers making the information input by the client center user interface 302 accessible to each of the vendors, and electronically publishing the retailer's catalog.

The fulfillment gateway processor 306 may further receive electronic customer orders (according to the published catalog) from the vendors (e.g., 106, 108, 110). Generally, customers are able to interact with the retailer (e.g., 112) from the vendors via the fulfillment gateway processor 306. In some aspects, the fulfillment gateway processor 306 further processes the orders in order to access and/or interact with a fulfillment option for each of the orders in order to orchestrate fulfillment of the orders. Generally, an order received at the fulfillment gateway processor 306 is enriched with all necessary details for order fulfillment (e.g., fulfillment type, number and type of items, facility to fulfill the order, etc.) and is forwarded to the fulfillment processor 310.

The database 308 is any suitable database (e.g., hierarchical databases, relational databases, non-relational databases, object-oriented databases, and so forth) for storing data relevant to the system 100. The data stored in the database may include store specific information (e.g., store hours, store catalogs, store location, product information, historical order information, and the like), vendor specific information (e.g., specific vendors, order history associated with each vendors, etc.), fulfillment specific information (e.g., specific delivery services (e.g., shipping carries, third-party delivery companies, etc.), historical fulfillment methods, etc.), and/or any additional information relevant to the system 100. Generally, the database 308 is an electronic database. In some aspects, the database 308 is the catalog service described herein.

The fulfillment processor 310 generally orchestrates the physical fulfillment of electronic orders. For example, based on an order fulfillment method designated by a customer in a respective order, the fulfillment processor 310 may communicate with relevant fulfillment services in order to instruct fulfillment of an order. For example, the fulfillment processor 310 may be in communication with the picking adapter 312 and/or the shipping adapter 314 in order to physically aggregate an order and/or dispatch the order to the customer. Generally, updated received at the fulfillment processor 310 during picking and/or delivery services (e.g., nil pick, item substitution, arrival timing of an order, and/or any additional information relevant to the order) is communicated back to the fulfillment gateway processor 306 and/or the customer 101 via the vendor 106, 108, 110.

The picking adapter 312 generally facilitates/electronically instructs the physical picking of items of an order within a facility of a retailer. In some aspects, the picking adapter 312 includes and/or cooperates with a processor (e.g., the fulfillment processor 310 and/or additional processors) in order to instruct the picking of an order. In one example, the picking adapter 312 via the fulfillment processor 310 electronically instructs a robot (e.g., a mobile robot within the facility of a retailer) and/or a person to locate and pick items in a retail facility of the retailer in order to fulfill the electronic order. Instructions for picking items of an order may include, for example, the location of the item(s) within the retail facility, the quantity of the item, and/or additional information useful in physically fulfilling an order.

The shipping adapter 314 generally facilitates/electronically instructs the delivery/order fulfillment method used for an order. In some aspects, the shipping adapter 314 includes and/or cooperates with a processor (e.g., the fulfillment processor 310 and/or additional processors) in order to physically fulfill the order. For example, the shipping adapter 314 via the fulfillment processor 310 communicates with an order fulfillment service (e.g., a shipping carrier, a third-party delivery service, etc.) in order to facilitate the transfer of a fulfilled order from the facility to the customer.

The retailer (or client side system) 112 includes a picking application 316. In some aspects, the picking application 316 is an application/website (for example of the retailer 112) generally viewable by an associate of the retailer 112 (or in some aspects of a vendor 106, 108, 110) that displays instructions for picking an order. For example, the picking application 316 may physically display the location within the facility of the items within a respective order and/or allow an associate to indicate when the relevant items have been picked. Picking generally refers to the act of physically locating and taking (i.e., picking) items of an order in order to physically aggregate the order. In other words, the picking application 316 may direct picking of the order. In one example, a picking application 316 indicates an order 111 ready to be picked, a UPC and quantity of the item enterable and associated with the products of the order 111 picked, and/or an indication that a pick walk has been completed.

The retailer 112 includes a delivery application 318. In some aspects the delivery application 318 is an application/website (for example of the retailer 112 and/or of a third-party delivery application) generally viewable by the retailer 112. The delivery application 318 may display instructions related to a specific form of order fulfillment. For example, an order placed for pickup may cause the delivery application 318 to instruct a user to place a picked order at a location within the retail facility designated for order pickup. In another example, an order placed for delivery may cause the delivery application 318 to instruct a user (e.g., with GPS instructions for driving to the location indicated by the customer for order drop off). In another example, an order placed for shipping may cause the delivery application 318 to instruct the printing of shipping labels (and any additional shipping related steps) in order to properly ship the order to a location indicated by the customer.

In some aspects, the hub 102 further includes and/or is in communication with a data lake 320. In some embodiments, the data lake 320 is an electronic platform which (in addition to string data) provides analytics including insights such as order count, top selling items, day wise sales, nil picks, cancellation trends, etc. In other words, the data lake 320 communicates with insights and data related to a retailer (e.g., 112) that are not necessarily related to the hub 102 and orders placed therethrough. In some aspects, the data lake obtains information concerning orders from the participants (e.g., the vendors 106, 108, 110) and a central hub processing resource (e.g., the hub 102) which accesses the data lake to obtain analytics information about products stored at the data lake. In some aspects, the analytics information comprises information concerning one or more of top selling products, daily sales, nil picks and cancellation trends.

Generally, any of the components of the system 100 and/or the hub 102 may be communicatively coupled over any suitable network. In some embodiments, the network(s) may be any suitable network or communication method such as, for example, a local area network (LAN), the Internet, wide area network (WAN), etc., communication link, other networks or communication channels with other devices and/or other such communications (not shown) or combination of two or more of such communication methods. In some aspects, there may be any combination of wired connections and/or wireless connections (e.g., Wi-Fi, Bluetooth, cellular, RF, and/or other such wireless communication) between the elements of the system 100.

Referring now to FIG. 3B, one example of the operation of the system of the hub 102 (as shown in FIG. 3A) is described.

At step 350, a catalog is uploaded via the client center user interface 302 to the store configuration service 304 of the hub 102 by the retailer. Generally, the catalog includes products (and relevant information associated with the products) that are available for sale at the retailer. In some aspects, additional store information is further uploaded along with the catalog (e.g., store hours, store location, etc.).

At step 352, the catalog is sent from the store configuration service 304 to the vendor. In some aspects, the additional information described relative to step 350 is further uploaded to the vendor(s). Once received at the vendor(s), the catalog information is viewable by a customer utilizing a vendor interface to view and/or purchase items.

At step 354, the catalog is sent from the store configuration service 304 (or directly from the client center user interface 302) to the fulfillment gateway processor 306. In some aspects, the fulfillment gateway processor 306 (either instead of or in addition to the store configuration service 304) uploads the catalog to the vendor(s) to be viewed by a customer via an interface of the vendor.

At step 356, the catalog is sent to the database 308. Generally, the catalog information is stored in the database 308 along with any relevant information (e.g., historical orders, item statuses, etc.) that may be relevant when placing/fulfilling an order. Generally, the catalog and/or any additional information stored in the database is accessible by the client center user interface 302, the vendors, etc., via the fulfillment gateway processor 306.

At step 358, the catalog or menu is sent from the database 308 to the fulfillment gateway processor 306. As described relative to step 356, the information stored in the database 308 is accessible by the fulfillment gateway processor 306. In some aspects, the fulfillment gateway processor 306 sends a signal indicating which information from the database 308 is desired, and the relevant information is sent to the fulfillment gateway processor 306.

At step 360, the catalog or menu is sent from the fulfillment gateway processor 306 to the vendor. Once received by the vendor the catalog and/or menu is generally viewable and/or accessible by a customer navigating an interface of a respective vendor. A customer is generally able to view catalogs from multiple retailers via a vendor and add items from a respective vendor into a virtual cart.

At step 362, updates are sent from the fulfillment gateway processor 306 to the vendor. Updates may include changes to states of an item (e.g., out of stock, low stock, etc.), changes to a catalog of a retailer, and/or any additional relevant updates. In some aspects, updates may be input via a retailer at the client center user interface, while in some aspects, updates may be determined at the fulfillment gateway processor 306. In still other examples, updates may be received from the fulfillment processor 310 (from updates received from retail stores via the picking adapter 312 and/or shipping adapter 314).

At step 364, an order is received from the vendor at the fulfillment gateway processor 306. This may be a customer order from the customer 101. In some aspects, multiple orders from multiple vendors are sent to and aggregated at the fulfillment gateway processor 306.

At step 366, the order is sent from the fulfillment gateway processer 306 to the fulfillment processor 310. The order is processed by the fulfillment processor 310. Processing of the order may include determining a fulfillment type for the order (e.g., pickup, delivery, shipping) and routing the order to specific applications/interfaces specific to the type of order fulfillment. The fulfillment processor 310 generally facilitates the picking of the order and/or the post picking order fulfillment of the order (e.g., from the facility to the customer).

At step 368, the order is sent from the fulfillment processor 310 to the picking adapter 312. Generally, the picking adapter 312 facilitates the physical picking of items of an order within a facility. The picking adapter 312 may aid in instructing an operator (e.g., robotic and/or manual) what items to pick and where in the facility the items reside. This may be accomplished by issuing electronic control signals, that in some examples directly control a robot.

At step 370, the order is sent from the picking adapter 312 to the retailer. The retailer picks the item in the order by physically locating the items in a facility of the retailer, and by aggregating the items of the order. In some aspects, an application/website of the retailer displays the items to be picked for an order (including item location and quantity). In some aspects the picking adapter sends a signal (e.g., via a network) to the application/website of the retailer, the signal including information associated with the order and items therein.

At step 372, the order is sent from the fulfillment processor 310 to the shipping adapter 314. Generally, the shipping adapter 314 facilitates the delivery of an order from a facility of the retailer to the customer that placed the order. In some aspects, the shipping adapter 314 is in communication with multiple order fulfillment providers (e.g., delivery drivers, shipping carriers, etc.). In some aspects, the fulfillment processor 310 sends a signal to the shipping adapter 314 indicating the type of order fulfillment desired, and the corresponding signals instruct the shipping adapter to facilitate order fulfillment accordingly. In some examples, some of these functions may be accomplished at least in part by issuing electronic control signals, that in some examples directly control machines such as robots and conveyors that are used in the shipping process.

At step 374, the order is sent from the shipping adapter 314 to the retailer. Once the item is picked, the item is shipped by an indicated order fulfillment provider (e.g., for delivery and/or for shipping). In some aspects, an application/website of the retailer displays order fulfillment specific actions to be taken by the retailer depending on the method of order fulfillment indicated by a customer. For example, an indication from a customer that an order is to be shipped may cause shipping processes to be facilitated via the application/website of the retailer (e.g., printing a shipping label, placing an aggregated order in an area of a facility designate for shipping, etc.). Similarly, an indication from a customer that an order is to be delivered may cause delivery processed to be facilitated via the application/website of the retailer (e.g., directing a delivery driver to a location designated by the customer for drop off of the order). Generally, the shipping adapter sends a signal (e.g., via a network) to the application/website of the retailer, and the signal includes information associated with the order and associated order fulfillment method.

At step 376, the retailer sends a picking status to the picking adapter 312. Generally, the picking status indicates whether the items of the order have been successfully picked. In some aspects, a non-successfully picked item (e.g., the item was out of stock) would indicate a nil-pick status in the picking status. A successfully picked item may indicate a successful pick status in the picking status.

At step 378, the picking adapter sends the picking status to the fulfillment processor 310. Generally, the picking status is used to update the customer (e.g., of the status of the order and items therein) and/or to update the status of items in the catalog viewable by a customer from the vendor. For example, a nil-pick status may cause the respective item to be displayed as out of stock on the vendor. The picking status may also be output to a customer to inform the customer that the items of their order have been aggregated.

At step 380, the retailer sends a shipping status to the shipping adapter 314. Generally, the shipping status indicates whether or not the order is successfully on the way to the customer (e.g., by shipping and/or delivery methods).

At step 382, the shipping adapter 314 sends shipping status to the fulfillment processor 310. Generally, the shipping status is used to update the customer on the status of the order. For example, when the order fulfillment method is shipping, a customer may receive a notification that the order has been shipped, and an estimated arrival date. In another example, when the order fulfillment method is delivery, a customer may receive a notification that the order is on its way, and an estimated arrival time.

It is generally contemplated that the steps and/or processes described relative to FIG. 3B may be performed separately and/or concurrently. For example, the processors (including the fulfillment gateway processor 306, the fulfillment processor 310, the picking adapter 312, the shipping adapter 314, and/or any additional processors and/or components) may perform actions at the same time. In other words, parallel processing may occur such that multiple of the steps described occur simultaneously. For example, a catalog may be downloaded at the fulfillment gateway processor 306 as orders from vendors are processed at the fulfillment processor 310.

In aspects where multiple functions are desired to occur at a single processor, operations may be prioritized. For example, order processing at the fulfillment gateway processor may be delegated before catalog downloading at the fulfillment gateway processor if there is a conflict.

In some embodiments, various processors send and/or receive signals to and from one another. In one example, a first processor processes orders, a second processor publishes retailer information to vendors, a third processor downloads information, and so forth. Any number of processors may perform respective tasks in parallel with one another. In another example, one processor may facilitate and/or instruct additional processors (e.g., according to a master-slave dynamic). In some aspects, processors send acknowledgements to one another upon receival of information from a respective processor. For example, a first processor may send information to a second processor (e.g., the fulfillment gateway processor may send order information to the fulfillment processor), and the second processor may send an acknowledgment to the first process indicating that the information has been successfully received. The process of sending and receiving acknowledgments may increase efficiency and speed of communications between processors and may decrease errors.

Referring now to FIG. 3C, one example of the fulfillment processor 310 processing orders is described. In some aspects, an order 390 is placed (e.g., via the vendors). The order 390 may indicate a specific facility at which the order is to be fulfilled or may not indicate a specific facility at which the order is to be fulfilled. In some aspects, when a facility is indicated in the order 390, a step 392 routes the order to the facility for fulfillment. Generally, the order is received from a vendor through the fulfillment gateway processor 306, processed at the fulfillment gateway processor 306 and is sent to the fulfillment processor 310, and is further sent to the picking adapter 312 and shipping adapter 314 for physical picking and fulfillment of the order at the facility. In aspects where there is no facility indicated with an order (e.g., a customer indicates a specific item desired for purchase but not the retailer and/or physical location selling the item), at a step 394 the fulfillment processor 310 may determine the facility to fulfill the order (e.g., based on quantity of the item in stock, sales price, location to the customer, and so forth). After a facility is determined, the order is routed to the facility for fulfillment.

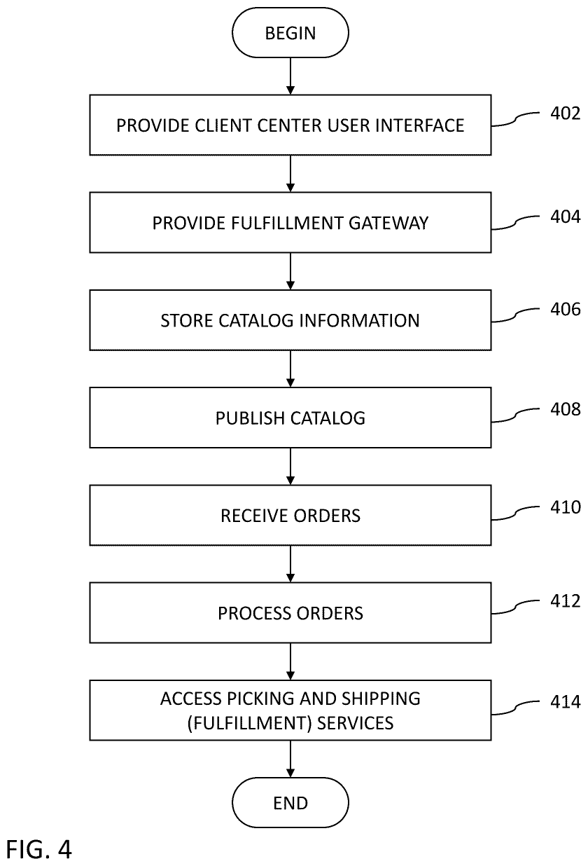

Referring now to FIG. 4, one example of an approach for integration and item fulfillment is described. In some aspects, the approach is executed by the system 100 and/or components of the system 100.

At step 402, a client center user interface is provided to receive a catalog and catalog information from a retailer and electronically stores the catalog information in an electronic database. In some aspects, the client center user interface is communicatively coupled with the electronic database, for example, over a communication network. In some embodiments, the catalog includes products for sale at a retailer (that is, for example, utilizing the client center user interface) and the catalog information is information associated with the products for sale (e.g., product name, product description, and so forth).

At step 404, a fulfillment gateway (e.g., including/using the fulfillment gateway processor 306 and the fulfillment processor 310) is provided, and the fulfillment gateway integrates the retailer with a plurality of marketplace vendors by making information input by the retailer via the client center user interface accessible to each of the plurality of marketplace vendors. Providing this gateway involves communicatively coupling at least the marketplace vendors, the client center user interface, and the electronic database with one another via the gateway and/or network(s). In some embodiments, a retailer enters the catalog and catalog information once through the client center user interface, and the catalog and catalog information is provided to each of the marketplace vendors is integrated with the retailer in one integration.

At step 406, the catalog information is stored in the electronic database. The electronic database may further store relevant data including historical orders, item status (e.g., out of stock, low stock, etc.) of the items in the catalog, fulfillment information, and so forth. Any information relevant to the systems and processes described herein may be stored in the database.

At step 408, the catalog is electronically published. Publishing the catalog generally entails making the catalog viewable by the vendors and/or by customers utilizing the vendor(s). For example, items in the catalog, when published, may be viewable and/or purchasable by a customer navigating an interface of a respective vendor.

At step 410, electronic orders are received according to the published catalog, the plurality of marketplace vendors interacting with the retailer via the fulfillment gateway. Generally, a customer is able to add items (e.g., from the catalog) into a virtual cart on an interface (e.g., a mobile application or website) of a retailer. The orders are received at the fulfillment gateway.

At step 412, electronic orders are processed. Generally, the orders are processed at the fulfillment gateway, and for each of the electronic orders, a facility location and order fulfillment method are designated. The fulfillment gateway may further facilitate the picking of an order and/or communicate with order fulfillment services for delivery of the order.

At step 414, a picking service and a shipping service are electronically accessed to fulfill the electronic order. The picking service electronically instructs a robot or a person to locate and pick an item in a retail facility of the retailer to fulfill the electronic order. The shipping service receives the item that has been picked and delivers the item to a customer. The picking and shipping services are in communication with the fulfillment gateway and facilitate picking and delivery of an order. The shipping service and picking service may further be in communication with respective applications/websites of the retailer fulfilling the order for instruction on picking and shipping processes.

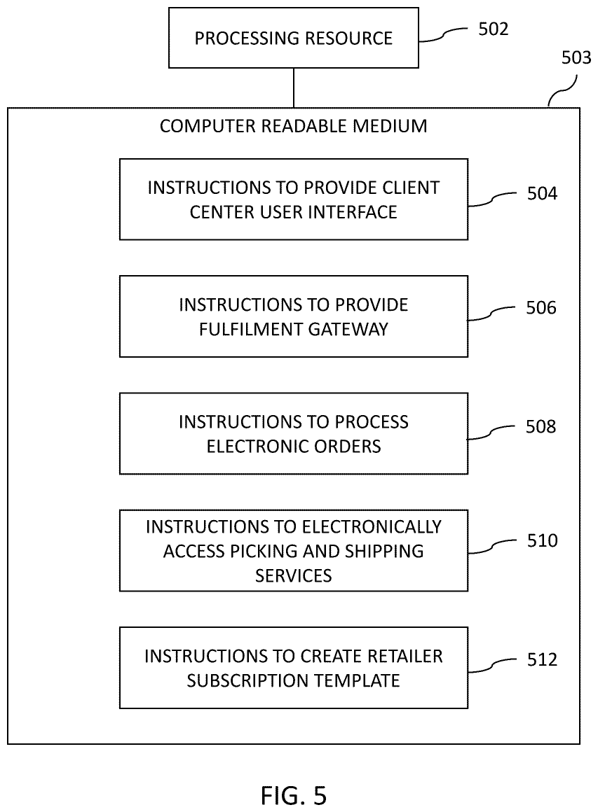

Referring now to FIG. 5, a computing system is shown in accordance with some embodiments. In some aspects, the computing system shown in FIG. 5 may include the system 100 and/or components of the system 100. The computing system includes a processing resource 502 (which may be a central hub processing resource), and a computer readable medium 503 (e.g., a non-transitory machine readable medium). The computer readable medium 503 stores instructions, that when executed, cause the processing resource 502 to implement an approach in accordance with some embodiments. In some aspects, the approach implemented by the processing resource 502 is the same and/or similar to the approach described in FIG. 4.

At step 504, the processing resource 502 executes instructions to provide a client center user interface. In some aspects, a client center user interface is provided to receive a catalog and catalog information from a retailer and electronically stores the catalog information in an electronic database. In some aspects, the client center user interface is communicatively coupled with the electronic database, for example, over a communication network. In some embodiments, the catalog includes products for sale at a retailer (that is, for example, utilizing the client center user interface) and the catalog information is information associated with the products for sale (e.g., product name, product description, and so forth).

At step 506, the processing resource 502 executes instructions to provide a fulfillment gateway. In some aspects, the fulfillment gateway integrates the retailer with a plurality of marketplace vendors by making information input by the retailer via the client center user interface accessible to each of the plurality of marketplace vendors. Providing this gateway involves communicatively coupling at least the marketplace vendors, the client center user interface, and the electronic database with one another via the gateway and/or network(s). In some embodiments, a retailer enters the catalog and catalog information once through the client center user interface, and the catalog and catalog information is provided to each of the marketplace vendors is integrated with the retailer in one integration. The catalog information may further be stored in an electronic database along with additional relevant data including historical orders, item status (e.g., out of stock, low stock, etc.) of the items in the catalog, fulfillment information, and so forth. Any information relevant to the systems and processes described herein may be stored in the database. In some aspects, the catalog is electronically published. Publishing the catalog generally entails making the catalog viewable by the vendors and/or by customers utilizing the vendor(s). For example, items in the catalog, when published, may be viewable and/or purchasable by a customer navigating an interface of a respective vendor.

At step 508, the processing resource 502 executes instructions to process electronic orders. Generally, electronic orders are received at the fulfillment gateway according to the published catalog, the plurality of marketplace vendors interacting with the retailer via the fulfillment gateway. Generally, a customer is able to add items (e.g., from the catalog) into a virtual cart on an interface (e.g., a mobile application or website) of a retailer. Generally, the orders are processed at the fulfillment gateway, and for each of the electronic orders, a facility location and order fulfillment method are designated. The fulfillment gateway may further facilitate the picking of an order and/or communicate with order fulfillment services for delivery of the order.

At step 510, the processing resource 502 executes instructions to electronically access picking and shipping services. In some aspects, a picking service and a shipping service are electronically accessed to fulfill the electronic order. The picking service electronically instructs a robot or a person to locate and pick an item in a retail facility of the retailer to fulfill the electronic order. The shipping service receives the item that has been picked and delivers the item to a customer. The picking and shipping services are in communication with the fulfillment gateway and facilitate picking and delivery of an order. The shipping service and picking service may further be in communication with respective applications/websites of the retailer fulfilling the order for instruction on picking and shipping processes.

At step 512, the processing resource 502 executes instructions to create a retailer subscription template. A retailer subscription may include the information (e.g., catalog information and/or additional store information including store hours, store location, and the like) and may process electronic customer orders based upon the template. In some aspects, the template includes guidelines for information to be input by a retailer. In some aspects, the retailer subscription subscribes a retailer to marketplace vendors and/or to delivery providers (e.g., for delivery and shipping fulfillment services). In some aspects, the template describes specific shippers or picking approaches provided by the retailer. In some aspects, a vendor may subscribe to specific shippers and/or picking approaches provided by the retailer (e.g., order delivery and not shipping). Generally, the retailer may dynamically change the template over time to include new shippers, shipping carriers, delivery methods, picking approaches, and/or additional order fulfillment methods.

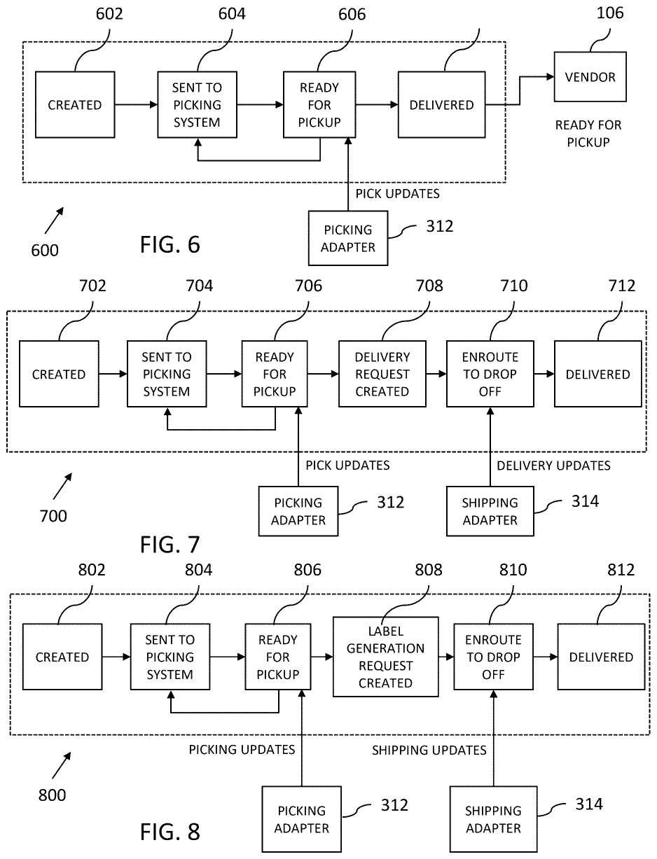

Referring now to FIG. 6, is an example process 600 of an order being fulfilled for pickup in accordance with some embodiments. In some aspects, the process utilizes components of the system 100 and/or components of the system 100, and/or aspects of the approaches described in FIGS. 4 and 5.

At step 602, an order is created/placed. The order is generally placed through a vendor and includes products for sale at a retailer in communication with the vendor (e.g., via a fulfillment gateway processor). After being processed, at a step 604, the order may be sent to a picking system (e.g., the picking adapter 312) in order for the items to be physically picked and aggregated within a facility.

At step 606, it is determined if the order is ready for pickup. In some aspects, further pick updates (e.g., nil pick, substitutions, etc.) may be received by/at the picking system and the order will continue to go through the picking process until the order has been completed and is ready for pickup. If it is determined that the order is ready for pickup, at step 608 the order is delivered to an area designated for pickup. In some aspects, a vendor (e.g., the vendor 106) picks up the order from the facility, and delivers the order to the customer.

Referring now to FIG. 7, an example process 700 of an order being fulfilled for delivery in accordance with some embodiments. In some aspects, the process utilizes components of the system 100 and/or components of the system 100, and/or aspects of the approaches described in FIGS. 4, 5, and 6.

At step 702, an order is created/placed. The order is generally placed through a vendor and includes products for sale at a retailer in communication with the vendor (e.g., via a fulfillment gateway processor). After being processed, at a step 704, the order may be sent to a picking system (e.g., the picking adapter 312) in order for the items to be physically picked and aggregated within a facility.

At step 706, it is determined if the order is ready for pickup. In some aspects, further pick updates (e.g., nil pick, substitutions, etc.) may be received by/at the picking system and the order will continue to go through the picking process until the order has been completed and is ready for pickup. If it is determined that the order is ready for pickup, at step 708 a delivery request is created. The delivery request may communicate with, for example, a delivery service (e.g., the shipping adapter 314) which will fulfill the delivery of the order.

At step 710, the order is picked up from the facility by the delivery service (e.g., a delivery driver) and is on the way to the customer. At step 712 the order is delivered to the customer.

Referring now to FIG. 8, an example process 800 of an order being fulfilled for shipping in accordance with some embodiments. In some aspects, the process utilizes components of the system 100 and/or components of the system 100, and/or aspects of the approaches described in FIGS. 4, 5, 6, and 7.

At step 802, an order is created/placed. The order is generally placed through a vendor and includes products for sale at a retailer in communication with the vendor (e.g., via a fulfillment gateway processor). After being processed, at a step 804, the order may be sent to a picking system (e.g., the picking adapter 312) in order for the items to be physically picked and aggregated within a facility. At step 806, it is determined if the order is ready for pickup. In some aspects, further pick updates (e.g., nil pick, substitutions, etc.) may be received by/at the picking system and the order will continue to go through the picking process until the order has been completed and is ready for pickup.

If it is determined that the order is ready for pickup, at step 808 a label generation request is created in order to create a shipping label to be placed on the order. The label generation request may communicate with, for example, a shipping service (e.g., the shipping adapter 314) which will fulfill the shipping of the order.

At step 810, the order is picked up from the facility by the shipping service (e.g., a shipping carrier) and is on the way to the customer. At step 812 the order is delivered to the customer.

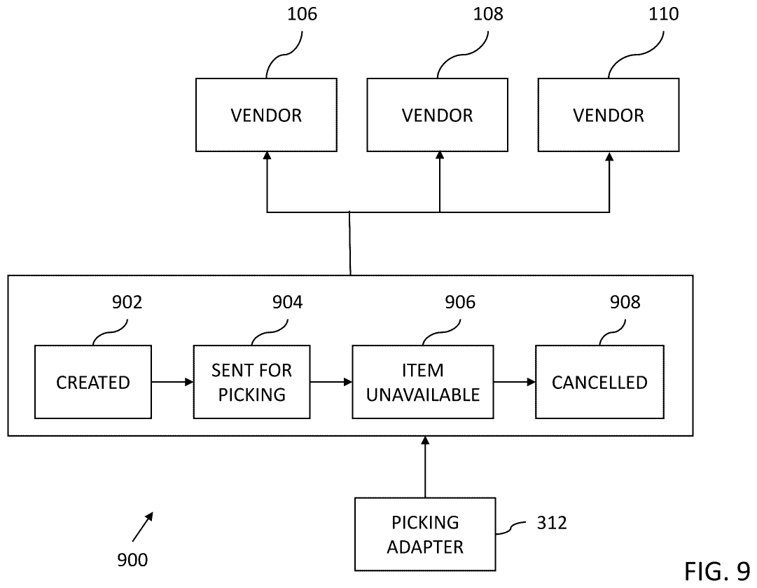

Referring now to FIG. 9, an example process 900 for an item being unavailable during order fulfilment in accordance with some embodiments. In some aspects, the process utilizes components of the system 100 and/or components of the system 100, and/or aspects of the approaches described in FIGS. 4, 5, 6, 7, and 8.

At step 902, an order is created/placed. The order is generally placed through a vendor (e.g., 106, 108, 110) and includes products for sale at a retailer in communication with the vendor (e.g., via a fulfillment gateway processor). After being processed, at a step 904, the order may be sent to a picking system (e.g., the picking adapter 312) in order for the items to be physically picked and aggregated within a facility.

At step 906, an item is nil picked (e.g., the item is out of stock when it was not anticipated to be) by the picking system, and at step 908 either the item in the order or the order itself is cancelled. If the item is cancelled and not the order, the process 900 may proceed similarly to 600, 700, and/or 800 depending on the designated fulfillment method. In some aspects, a notice that the item that was nil picked is out of stock is uploaded to the vendors 106, 108, 110. In some aspects, the retailer is able to customize additional actions triggered by a state change that occurs during shipping for picking. In the present example, the action triggered is the cancellation of the order and the state change is a nil pick. In some aspects, the out-of-stock alert or indicator is associated with a product of a customer order that was nil picked. Another action related to a nil pick state change may be the triggering of an out-of-stock alert or indicator across all marketplace vendors. Any alternate states (e.g., low stock, wait required, fulfillment delayed, etc.) and actions (e.g., customer alerts, substitution suggestions, order cancellation, etc.) may be designated by the retailer.

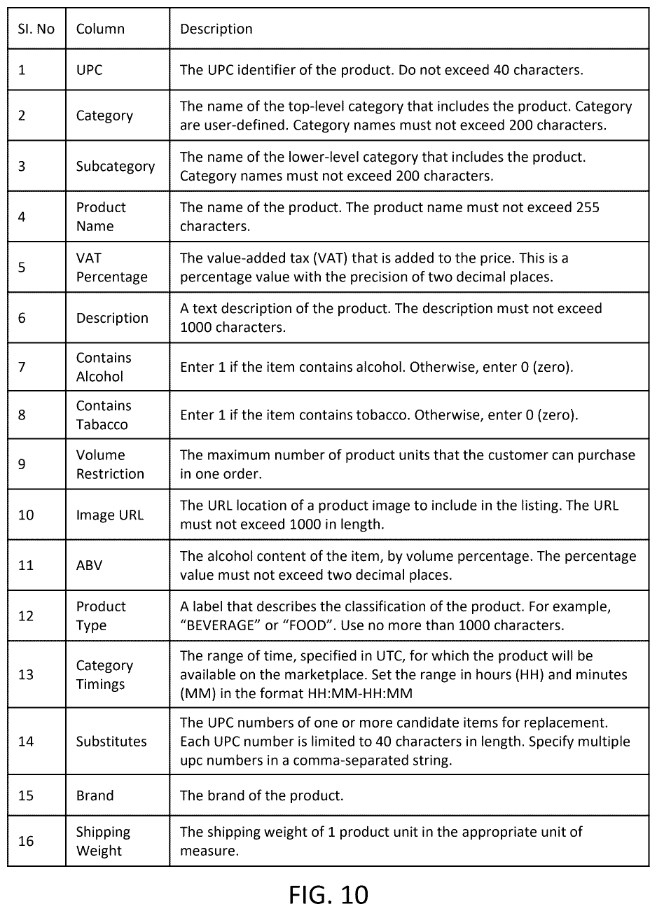

Referring now to FIG. 10, an example catalog file is shown in accordance with some embodiments. In some aspects, a catalog is considered the listing of products and catalog information is the information/criteria associated with each product in the catalog. The catalog file indicates information required when an associated retailer inputs an item into the catalog.

For example, an item/product in the catalog may require a universal product code (UPC) identifier of the product, a category (e.g., a name of a top-level category the includes the product), a subcategory (e.g., the name of a lower-level category the includes the product), and/or a product name. In one example, the product may be a specific type of mobile phone, the category may be electronics, the subcategory may be mobile phones, and the product name may be the specific model of the phone. Additional criteria related to a product in the catalog may include a value-added tax (VAT) percentage added to the price, a text description of the product, a product type, a brand of the product, a shipping weight, and so forth. In some embodiments, criteria indicates if an item contains alcohol, the ABV of a product that does contain alcohol, and/or if an item contains tobacco. Further criteria may include the UPC numbers of potential substitute items (e.g., in the event an item is unavailable), category timings (e.g., what times the product will be available for purchase), a volume restriction (e.g., a maximum number of product units a customer may purchase in one order), and/or an image URL (e.g., linking a product image to include in the listing on vendor). In some aspects, certain of the described criteria may be required in order to upload a product to the catalog, while others are optional.

In some aspects, the retailer may not be allowed to enter catalog information into the hub without meeting the criteria of the catalog file. For example, catalog information being entered at the hub may be scanned for conformance to the catalog information and feedback given to the retailer when the information being input is not in conformance with the catalog file.

The listing of criteria herein is generally understood to be non-exhaustive. Other examples are possible.

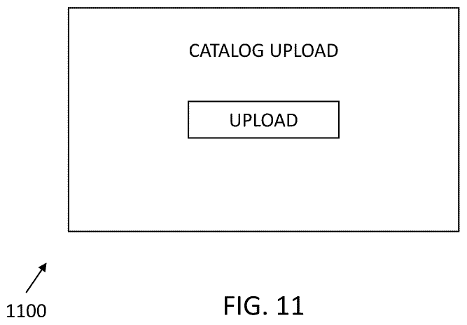

Referring now to FIG. 11, a user interface 1100 is shown in accordance with some embodiments. In some aspects, the user interface 1100 displays a view of a catalog upload interface. A retailer may interact with the catalog upload interface in order to upload a catalog (e.g., comprising products for sale at a retailer) and associated catalog information. The user interface may include a plurality of input means (e.g., text fields, images, etc.) in order to input the catalog information. Further, a user may select the upload button indicated to upload the catalog and catalog information to a plurality of marketplace vendors when indicated.

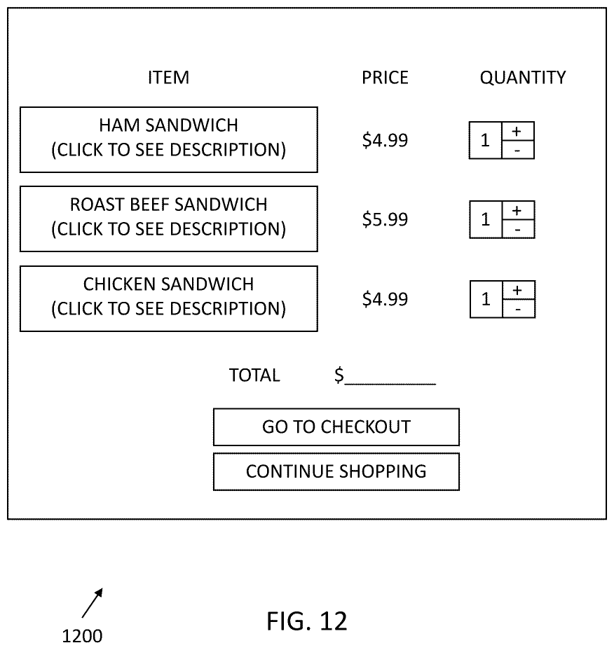

Referring now to FIG. 12, a user interface 1200 of a vendor viewing the catalog information uploaded (e.g., in FIG. 11) is shown in accordance with some embodiments. In some aspects, the user interface 1200 of a vendor receives a catalog from a retailer including catalog information associated with the products in the catalog. For example, a vendor and/or a customer navigating the user interface 1200 of the vendor, may view the product (e.g., including the product name), a price of the product. In some aspects, a customer may further select a quantity of an item desired for purchase, and a total dollar value for all items selected for purchase may be further displayed on the user interface 1200. After an item is added to a cart for purchase, a user may select an option to continue shopping or may select an option to go to checkout. There may be any additional selectable functions on the user interface 1200 (e.g., a back button, remove from cart, place the order, enter payment information, etc.) relevant to placing an order.

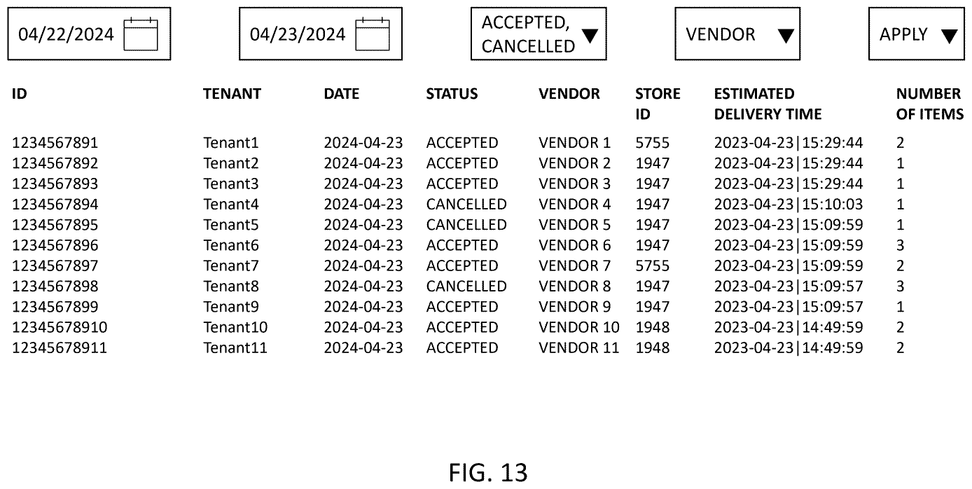

Referring now to FIG. 13, an example table of orders as viewed by a retailer (e.g., at a facility fulfilling the orders) is shown. The table generally includes an ID associated with an order, a tenant of an order, a date the order was placed, a status of the order (e.g., accepted, cancelled, fulfilled, in progress, etc.), a specific vendor the order was places through, a store ID of the location fulfilling the order, and/or an estimated delivery time. It is generally understood that these are illustrative examples of order characteristics that may be viewed by a retailer, and that additional characteristics may be used (e.g., number of items in an order, fulfillment type, items in the order, and so forth). An associate, e.g., of the retailer, may view the table in order to facilitate the fulfillment of orders.

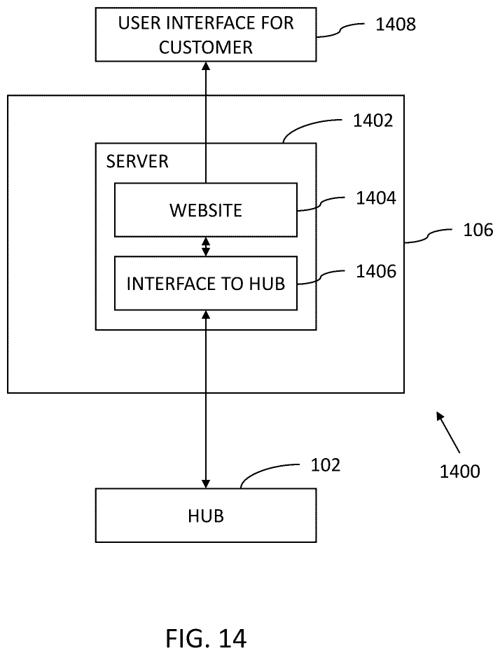

Referring now to FIG. 14, a system 1400 including a vendor 106 is shown in accordance with some embodiments. In some aspects, the system 1400 may be the same or similar to the system 100 and/or components of the system 100. For example, the system 1400 generally includes a vendor 106 communicatively coupled with a user interface 1408 and the hub 102 (shown in FIG. 1).

Generally, the vendor 106 includes a server 1402 further including and/or interfacing with a website 1404 (and/or a mobile application) of the vendor 106, and an interface 1406 to the hub 102. Generally, a customer will enter input (e.g., place an order) through the user interface 1408, and the order is sent to the hub 102 via the server 1402 and components thereof. The hub 102 and the user interface 1408 may communicate (e.g., order updates, order status, etc.) via the vendor 106 in accordance with some embodiments. While the vendor 106 is shown, it is generally contemplated that the architecture of the system 1400 may additionally apply to marketplaces 104, 105 and vendors 108, 110.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
an electronic database;
a central hub processing resource coupled to the electronic database; and
a computer readable medium storing instructions that, when executed by the central hub processing resource cause the central hub processing resource to:
provide a client center user interface to receive a catalog and catalog information from a client side system and electronically store the catalog information in the electronic database;
provide a fulfillment gateway to:
integrate the client side system with a plurality of hub participants by making information input by the client side system via the client center user interface accessible to each of the plurality of hub participants, wherein the information is stored in the electronic database;
electronically publish the catalog; and
receive electronic orders according to the published catalog, the plurality of hub participants interacting with the client side system via the fulfillment gateway;
process the electronic orders; and
electronically access, for each of the electronic orders, a fulfillment option to fulfill the electronic order;
wherein the fulfillment option:
electronically instructs a robot or a person to locate and pick an item in a retail facility of the client side system to fulfill the electronic order; and
receives the item that has been picked and delivers the item to a customer.

2. The system of claim 1, wherein the central hub processing resource comprises multiple processing resources.

3. The system of claim 1, wherein the central hub processing resource creates a client side system subscription template from information received from the client side system via the client center user interface and processes the electronic orders based upon the template.

4. The system of claim 3, wherein the template describes specific shippers or picking approaches provided by the client side system.

5. The system of claim 3, wherein the client side system dynamically changes the template over time.

6. The system of claim 1, wherein the client side system instructs, via the client center user interface, the central hub processing resource to customize an action triggered by a state change that occurs during shipping or picking.

7. The system of claim 6, wherein:
the state change is a nil pick and the action is triggering an out-of-stock alert or indicator across all hub participants; and
the out-of-stock alert or indicator is associated with a product of the electronic customer order that is nil picked.

8. The system of claim 1, wherein the catalog information comprises information concerning one or more of products, prices of the products, and availability of the products.

9. The system of claim 1, further comprising a data lake.

10. The system of claim 9, wherein the data lake obtains information concerning orders from the participants and the central hub processing resource accesses the data lake to obtain analytic information about products stored at the data lake.

11. The system of claim 10, wherein the analytic information comprises information concerning one or more of: top selling products, daily sales, nil picks and cancellation trends.

12. A method comprising:
providing a client center user interface to receive a catalog and catalog information from a retailer and electronically storing the catalog information in an electronic database;
providing a fulfillment gateway, the fulfillment gateway:
integrating the retailer with a plurality of marketplace vendors by making information input by the retailer via the client center user interface accessible to each of the plurality of marketplace vendors, wherein the information is stored in the electronic database;
electronically publishing the catalog; and
receiving electronic orders according to the published catalog, the plurality of marketplace vendors interacting with the retailer via the fulfillment gateway;
processing the electronic orders; and
electronically accessing, for each of the electronic orders, a picking service and a shipping service to fulfill the electronic order;
wherein the picking service electronically instructs a robot or a person to locate and pick an item in a retail facility of the retailer to fulfill the electronic order;
wherein the shipping service receives the item that has been picked and delivers the item to a customer.

13. The method of claim 12, further comprising:
creating a retailer subscription template from information received from the retailer and processing the electronic customer order based upon the template.

14. The method of claim 13, wherein the template describes specific shippers or picking approaches provided by the retailer.

15. The method of claim 13, wherein the retailer dynamically changes the template over time.

16. The method of claim 12, wherein the retailer customizes an action triggered by a state change that occurs during shipping or picking.

17. The method of claim 16, wherein the state change is a nil pick and the action is triggering an out-of-stock alert or indicator across all marketplace vendors;
wherein the out-of-stock alert or indicator is associated with a product of the electronic customer order that is nil picked.

18. The method of claim 12, wherein the catalog information comprises information concerning one or more of products, prices of the products, and availability of the products.

19. A non-transitory machine readable medium storing instructions that, when executed, cause a central hub processing resource to:
provide a client center user interface to receive a catalog and catalog information from a retailer and electronically storing the catalog information in an electronic database;
provide a fulfillment gateway, wherein the fulfillment gateway:
integrates the retailer with a plurality of marketplace vendors by making information input by the retailer via the client center user interface accessible to each of the plurality of marketplace vendors, wherein the information is stored in the electronic database;
electronically publishes the catalog; and
receives electronic orders according to the published catalog, the plurality of marketplace vendors interacting with the retailer via the fulfillment gateway;
process the electronic orders; and
electronically access, for each of the electronic orders, a picking service and a shipping service to fulfill the electronic order;
wherein the picking service electronically instructs a robot or a person to locate and pick an item in a retail facility of the retailer to fulfill the electronic order;
wherein the shipping service receives the item that has been picked and delivers the item to a customer.

20. The non-transitory machine readable medium of claim 19, wherein the instructions further cause the central hub processing resource to create a retailer subscription template according to information received from the retailer and process the electronic customer order based upon the template.
